(19) United States
(12) Patent Application Publication
(10) Pub. No.: US 2016/0132192 A1
(43) Pub. Date: May 12, 2016

(54) Active Menu with Surfacing Notifications

(71) Applicant: HERE Global B.V., Veldhoven (NL)

(72) Inventors: Charles Sutton, San Francisco, CA (US); Steven Kish, San Francisco, CA (US); Brody Larson, San Mateo, CA (US); Nicole Ryan, San Francisco, CA (US); Pascal Wever, Los Angeles, CA (US); Markus Eklund, Pleasanton, CA (US)

(21) Appl. No.: 14/539,589

(22) Filed: Nov. 12, 2014

(51) Int. Cl. G06F 3/0482; H04L 12/58; G06F 3/0481

(52) U.S. Cl. CPC G06F 3/0482; G06F 3/04817; H04L 51/24

(57) ABSTRACT

In one example, a mobile device is configured to display video images. The video images may be displayed in connection with collecting the video images or as part of a playback of previously recorded video images. The mobile device may identify an operating state of the mobile device and generate a user message indicative of the operating state. The mobile device may display a graphical indicium of the user message on the user interface simultaneous to the display of the video on the user interface.

### FIELD

The following disclosure relates to notifications on a mobile device, or more particularly, systems and algorithms for an active menu with surfacing notifications.

### BACKGROUND

Mobile devices include smartphones, personal digital assistants, tablet computers, laptop computers, personal video recorders, personal video players, or other electronic devices. Mobile device users typically face a myriad of settings in order to configure a mobile device. Mobile devices may also display notifications. The notifications may take the form of a dedicated pop-up message displayed on the screen.

In some applications, these notifications and or settings menus are disruptive of the primary function of the mobile device. Some of these types of primary functions include media playing, media recording, and video communication. For example, a mobile device playing media must pause the media in order to display a notification or change a setting. Challenges remain in developing a more streamlined notification center and settings menus for mobile devices.

### SUMMARY

In one example, a mobile device is configured to display video images. The video images may be displayed in connection with collecting the video images or as part of a playback of previously recorded video images. The mobile device may identify an operating state of the mobile device and generate a user message indicative of the operating state. The mobile device may display a graphical indicium of the user message on the user interface simultaneous to the display of the video on the user interface.

### BRIEF DESCRIPTION OF THE DRAWINGS

Exemplary embodiments are described herein with reference to the following drawings.

FIG. 1. illustrates an example system for an active menu with surfacing notifications.

FIG. 2A illustrates an example media interface and surfacing notifications.

FIG. 2B illustrates another example media interface and surfacing notifications.

FIG. 3A illustrates an example transparent device settings menu.

FIG. 3B illustrates an example expanded notification.

FIG. 4A illustrates another example expanded notification.

FIG. 4B illustrates another example expanded notification.

FIGS. 5A and 5B illustrate an example gesture to sequence from surfacing notification to device settings menu.

FIGS. 6A, 6B, and 6C illustrate an example gesture to sequence device settings menu to expanded notification to pre-scrolled menu.

FIG. 7 illustrates an example mobile device of the system of FIG. 1.

FIG. 8 illustrates an example flow chart for surfacing notifications.

### DETAILED DESCRIPTION

Mobile device users typically face a myriad of settings in order to configure a mobile device. The settings are often set up in hierarchical menus accessible via a touch interface. Hierarchical menus are menus in which a selection on an initial menu leads to a new menu, and so on, through two or more levels. The initial menu is typically invoked by pressing a dedicated hard key (e.g., mechanical button or switch) or selecting a soft widget icon button on a touchscreen of the mobile device. The users must navigate through the hierarchy to reach the desired setting.

The mobile devices may also include a notification system. In many mobile devices, users may be alerted of notifications via a separate notifications center. The notification center may send pop-up messages that are displayed at the time of notification. These notification messages may also include soft toggle buttons that allow a user to toggle on/off select functionality (e.g., enable or disable WiFi, enable or disable location based services, or other features). Users may be able to expand a notification via a drag gesture or select the notification to open the application related to the notification.

In any of these examples, the settings menu and notifications are effectively separated. It is difficult to determine a location on the settings menu that corresponds to a particular notification. Moreover, if a user changes his/her mind after dismissing a settings related notification, he/she may not know where in the settings menu hierarchy to navigate to in order to change the desired setting. As small devices become ever more powerful, the menu hierarchy also increases in complexity and size.

The following embodiments include methods and systems to merge the settings menu and the notification system. In addition, the notification system includes an initial non-textual notification that is displayed without disrupting media display or collection on the mobile device. The initial non-texture notification may be a surfacing notification because it appears near the edge of the display as opposed to a pop-up message. In addition, the following embodiments include an initial non-textual notification that expands to one or more intermediate stages as well as the settings menu through a single gesture or multi-staged gesture. The settings menu is an active menu because the menu is navigation behind the scenes to the particular setting associated with the notification. Thus, a use does not need to navigation the hierarchical menus but is taken directly from the surfacing notification to the active menu.

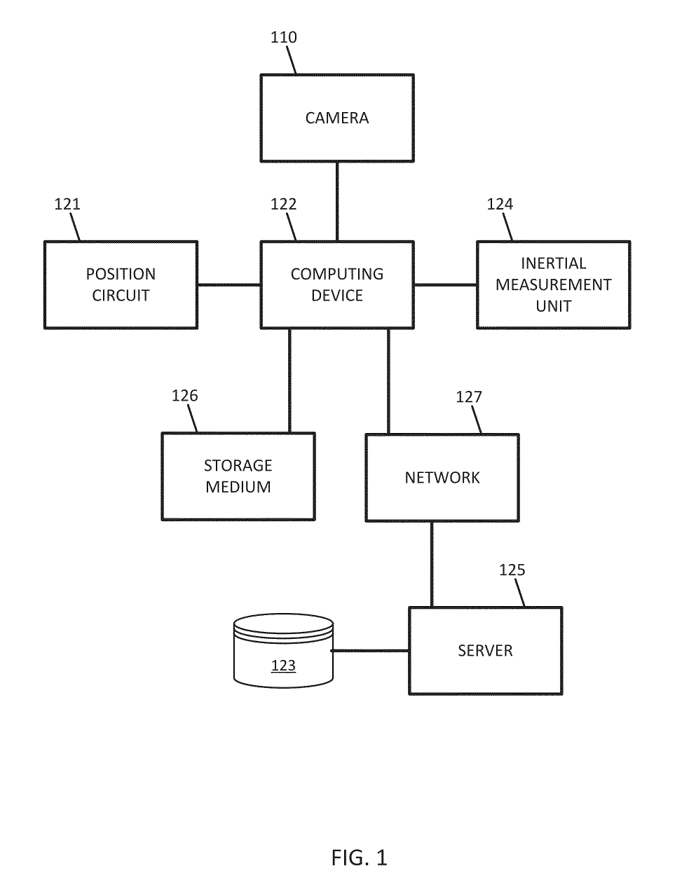

FIG. 1. illustrates an example system for an active menu with surfacing notifications. The system includes a computing device 122 integrated with or externally connected to one or more of a camera 110, position circuitry 121, a storage medium 126, and an inertial measurement unit (IMU) 124. The computing device 122 may be coupled with a network 127. Additional, different, or fewer components may be provided. For example, many computing devices 122 may connect with the network 127. Multiple cameras 110 may be connected to the computing device 122. In one embodiment, the computing device is coupled to a database 123 and/or map server 125. The database 123 may be a geographic database including road links or segments.

The computing device 122 may be configured to collect video through camera 110. The computing device 122 may display the video on a user interface of the video collection device as the camera 110 collects video. Alternatively, the computing device 122 may re-play video previous collected video or play video stored on the storage medium 126 or downloaded from the network 127.

The computing device 122 may identify an operating state of the video collection device. The operating state may be a primary operating state or a secondary operating state. The primary operating state may relate to a critical function of the computing device 122. The primary operating state may be a storage capacity state of the computing device 122 or a battery life of the computing device 122. The secondary operating state may relate to a wireless network, an operating system update, a mobile application update, a map data download status, a location status, or other features.

The computing device 122 may generate a user message indicative of the operating state. The operating state may take one of multiple severity levels. The severity levels may be an alert level, advisory level, and informational level. Multiple sub-levels may be included for each level. The alert levels may include urgent alerts and non-urgent alerts. Urgent alerts may be critical to the operation of the computing device 122. Non-urgent alerts may become urgent alerts over time. Urgent alerts may be persistent (i.e., they remain displayed until addressed). Non-urgent alerts may be non-persistent (e.g., they may be dismissed by the user). The advisory level may include critical advisories and non-critical advisories. The information level may include user request messages, system messages, and push messages.

The computing device 122 may identify a non-critical operating state of the computing device 122 and generate a non-critical user message indicative of the operating state. The non-critical user message may be displayed on the user interface simultaneous to the display of the video on the user interface.

The computing device 122 may generate a graphical indicium or indicator of the user message. The graphical indicator may be a small tab. The graphical indicator includes a series of pixels and does not interrupt the primary function of the computing device 122. In one example, the graphical indicator includes no text (e.g., non-textual). The graphical indicator may be coded by a color, placement, or shape. In one example, one color is used for each severity level of the operating state. One color (e.g., red) may indicate an alert level, another color (e.g., green) may indicate an advisory level, and a third color (e.g., white) may indicate an informational level. One placement (e.g., top of the screen) may indicate an alert level, another placement (e.g., left side of the screen) may indicate an advisory level, and a third color (e.g., right side of the screen) may indicate an informational level.

One shape (e.g., rectangle) may indicate an alert level, another shape (e.g., circle) may indicate an advisory level, and a third shape (e.g., triangle) may indicate an informational level. The shapes may be transparent and partially overlay the primary function of the computing device 122. The graphical indicator may have a predetermined size. The size may be a specific number of pixels (e.g., 100). The size may be a predetermined number (e.g., 1-10) of rows of pixels. The size may be a specific proportion of the screen size (e.g., 1%, 2%, or 5%).

The notifications may be prioritized according to categories or severity level. For example, informational notifications may only be shown when there are no advisory notifications or alert notifications. Advisory notifications may only be shown when there are no alert notifications. That is, the computing device 122 may display only a graphical indicator for an alert notification when such a notification exists.

The computing device 122 is configured to display a graphical indicator of the user message on the user interface simultaneous to the display of the video on the user interface. The graphical indicator may be displayed outside of the video on the user interface. The user may activate the graphical indicator through a touchscreen. The computing device 122 may receive a user input on the graphical indicator. The user input may be a single touch, a select and drag motion, or another gesture. In response, the computing device 122 is configured to display settings panel in response to the user input.

The primary function of the computing device 122 may be displaying media either at the time of collection or later playback. The graphical indicator may be displayed at the without disrupting the media. The graphical indicator may be small and displayed at an edge of the display. The graphical indicator may be semi-transparent such that the media is view through the graphical indicator.

The media may be supplemented with metadata collected by the computing device 122. The position circuitry 121 may generate location data (e.g., latitude and longitude coordinates) associated with a current position of the computing device 122. The location data may be stored in a file (e.g., in storage medium 126) with the video collected by the camera 110. For example, each frame may be associated with a location stamp. Each frame may also be associated with a time stamp. In one example, the computing device 122 displays the location data overlaid on the video. The computing device 122 may calculate the speed of the computing device 122 based on a sequence of location data (e.g., the derivative of location data).

The media may be supplemented with metadata collected by the IMU 124. The IMU 124 may include one or more of an accelerometer, a gyroscope, and a magnetic sensor. The IMU 124 may calculate one or more of heading data, speed data, acceleration data, or orientation data of the computing device 122 (“motion data”). The motion data may be stored in a file (e.g., in storage medium 126) with the video collected by the camera 110. For example, each frame may be associated with a motion data stamp. In one example, the computing device 122 displays the motion data overlaid on the video. Other metadata may be collected such as temperature, pressure, and altitude.

The computing device 122 may transmit the video, the location data, and the motion data to the server 125 via the network 127. The server 125 may store video including time stamps, location stamps, and/or motion stamps in the database 123. In another example, the computing device 122 may report current locations of the computing device 122 to the server 125, which accesses geographic data from the database 123. For example, the server 125 may send map information (e.g., road segments, nodes, and points of interest) to the computing device 122.

As alternatives to a standalone media device, the computing device 122 may be a smart phone, a mobile phone, a personal digital assistant (“PDA”), a tablet computer, a notebook computer, a personal navigation device (“PND”), a portable navigation device, and/or any other known or later developed portable or mobile computing device.

The phrase “coupled with” is defined to mean directly connected to or indirectly connected through one or more intermediate components. Such intermediate components may include hardware and/or software-based components. The computing resources may be divided between the server 125 and the mobile device 122. In some embodiments, the server 125 performs a majority of the processing. In other embodiments, the mobile device 122 or the workstation 128 performs a majority of the processing. In another example, the processing is divided substantially evenly between the server 125 and the mobile device 122 or workstation 128.

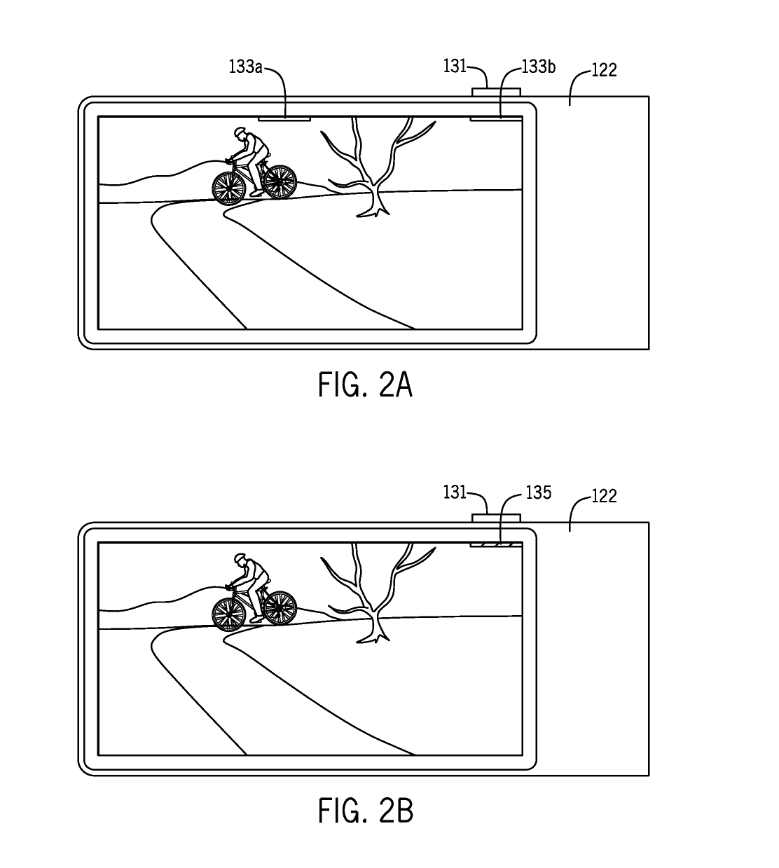

FIG. 2A illustrates an example media interface and surfacing notifications. The computing device 122 may include a user input 131 (e.g., a button) and a display including media collected by the camera 110. The display may also include graphical indicators 133a and 133b that represent an alert level, advisory level, or an informational level. The graphical indicators 133a and 133b may be thin enough to not interfere with the video on the computing device 122. The width of the graphical indicators 133a and 133b may be configurable. The graphical indicators 133a and 133b may be positioned near the edge of the media. One of the graphical indicators 133a and 133b may represent the alert level and the other a non-urgent level. The graphical indicators 133a and 133b may change in size (e.g., length or width) as the number of notifications associated with the indicator changes.

FIG. 2B illustrates another example media interface and surfacing notifications. One of the graphical indicators may represent one security level (alert level, advisory level, or informational level) and the other graphical indicator may represent another security level. Different security levels may be represented by different colors for the graphical indicators, different positions for the graphical indicators, or different shapes or sizes for the graphical indicators. For example, red may represented an alert, blue may represent an advisory, and green may represent an informational notice. In one example, the alerts are displayed on the right size (e.g., indicator 135) and advisory or informational notices are display on the middle or left, respectively.

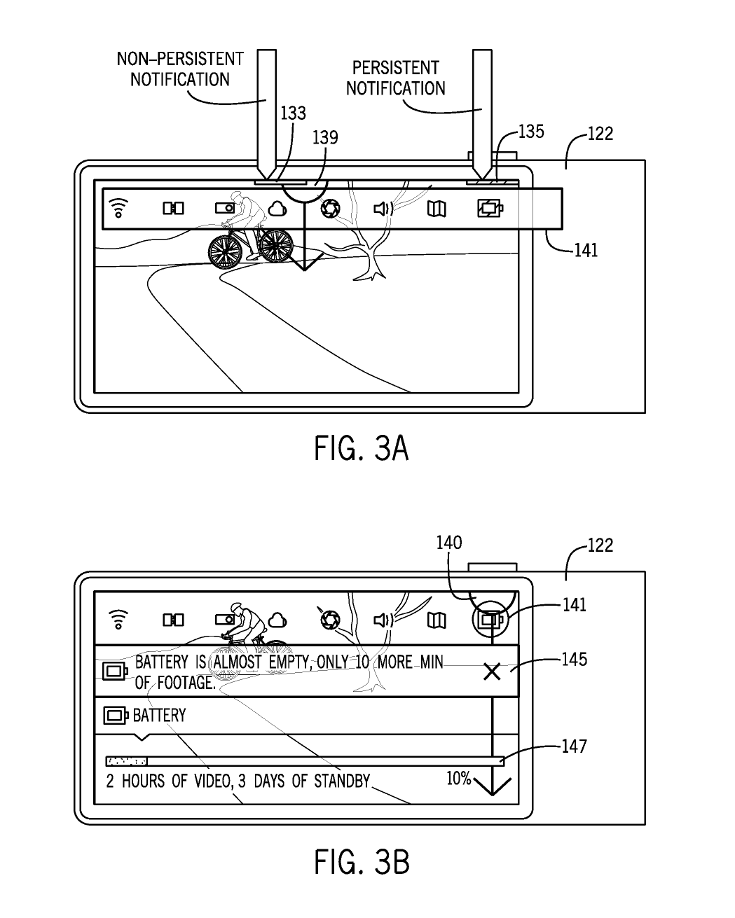

FIG. 3A illustrates an example transparent device settings menu 141. The graphical indicators may include non-persistent notification indicator 133 and persistent indicator 135. As illustrated by arrow 139, the user may provide an input to drag or scroll the notifications indicators to reveal the device settings menu 141. In one example, the notification indicators may be arranged to align with components of the device settings menu 141. The device settings menu 141 may include components for network settings, accessory settings, device settings, cloud settings, capture settings, audio settings, location settings, and battery settings. The device settings menu 141 may be semi-transparent to not interrupt the media displayed by the computing device 122.

FIG. 3B illustrates an example expanded notification. As illustrated by arrow 140, the user may provide an input to drag or scroll the device settings menu 141 to an expanded notification 145. The input represented by arrow 139 may be a continuous motion to the motion represented by arrow 140. For example, an alert indicator may be presented near the top of the display, the user may provide an input to drag the indicator to reveal the device settings menu 141 and further provide an input to drag the device settings menu 141 to reveal an expanded notification 145. The expanded notification 145 may provide more details of the basis of the notification or alert indicators.

The display may also include a menu component 147. The menu component 147 may include the menu settings related to the indicators. For example, the menu component 147 may be accessible from a menu tree (e.g., series of menus), but also directly accessible from the indicators as shown by arrow 139. The menu component 147 may describe the status of the computing device that led to the alert, notification, or informational notice.

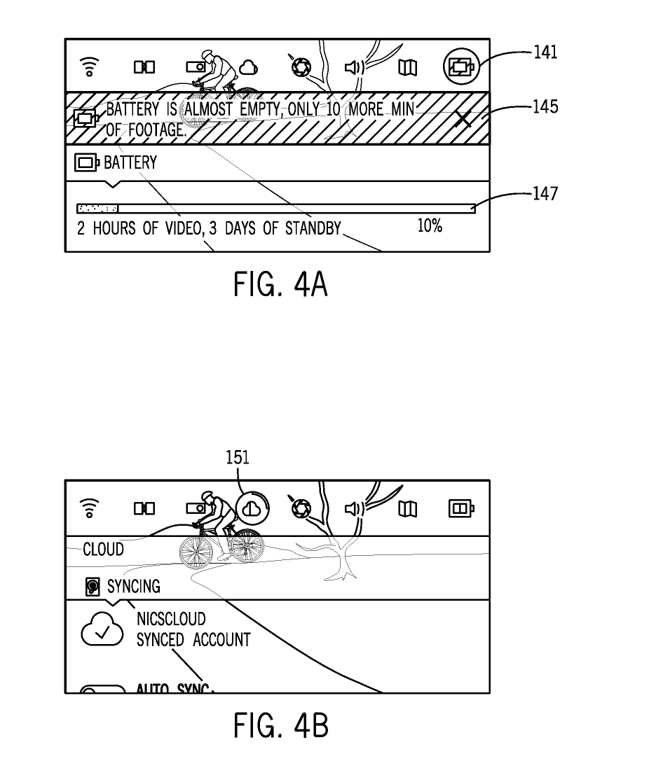

FIG. 4A illustrates another example expanded notification. The device settings menu 141 may be encoded to represent the level of the indicator. A matching encoding may be applied to the expanded notification 145 and the menu component 147. For example, the indicator may be red to represent an alert, the image of the battery in the device settings menu 141 may be red, and the expanded notification 145 may be highlighted in red.

FIG. 4B illustrates another example expanded notification. Additional data may be conveyed by the device settings menu 141. For example, cloud icon 151 includes an animation that indicates a cloud syncing is taking place.

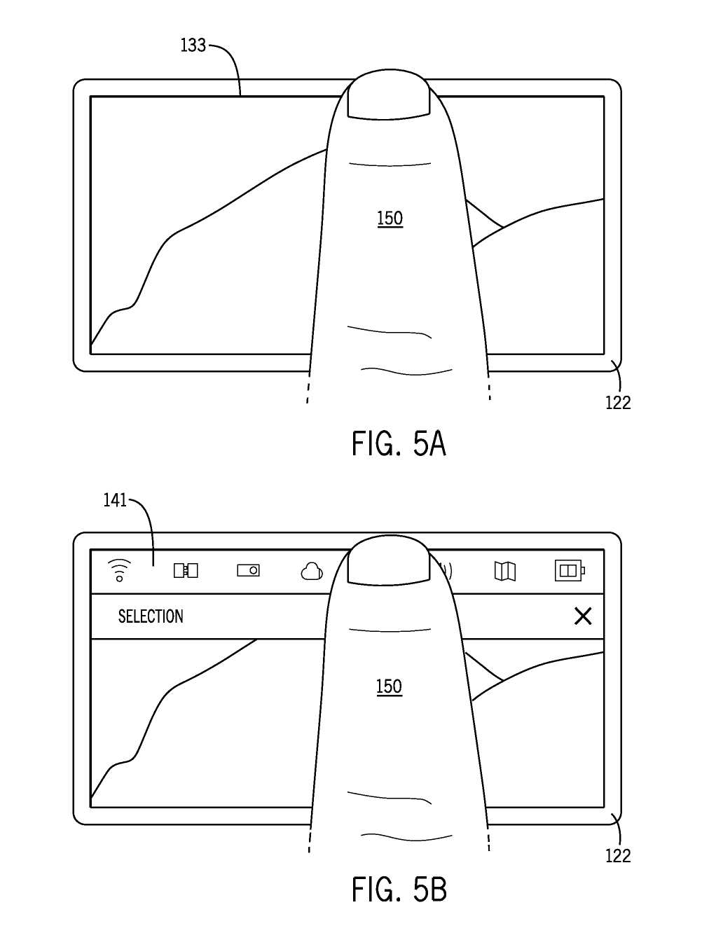

FIGS. 5A and 5B illustrate an example gesture to sequence from surfacing notification to device settings menu. In FIG. 5A, the graphical indicator 133 is minimally visible near the top edge of the screen. Rather than an obtrusive pop-up message, the user is informed that a notification is ready for viewing by the appearance of the graphical indicator 133. An input device 150 (e.g., a human finger) drags the graphical indicator 133 to reveal the device settings menu 141.

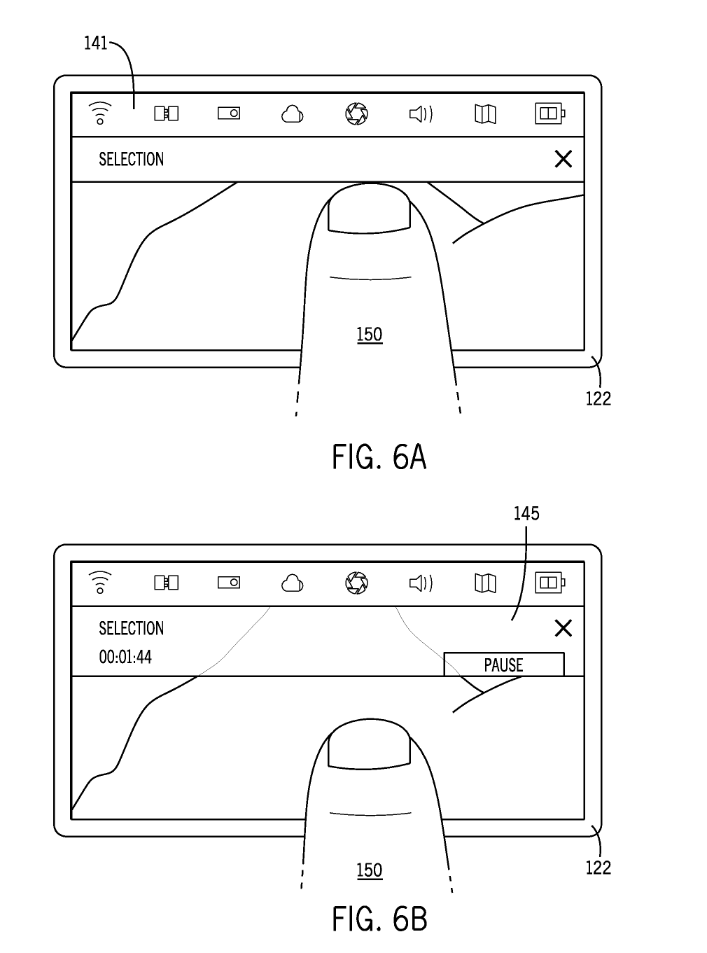

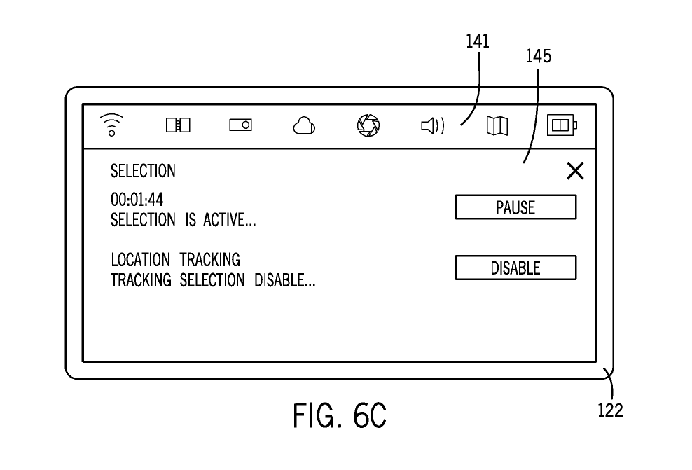

FIGS. 6A, 6B, and 6C illustrate an example gesture to sequence device settings menu to expanded notification to pre-scrolled menu. The input device 150 may extend the dragging motion from FIGS. 5A and 5B to scroll the device settings menu 141 to the expanded notification 145. The input device 150 may extend the dragging motion further to reveal the menu component 147. The menu component 147 may include the settings normally available from a series of menus and directly accessible from the graphical indicator 133.

The computing device 122 may include a lookup table that associates potential notifications with menu locations. The menu locations may include a submenu identifier and a position value. For example, a battery notification may include a submenu identifier including power settings and a position value that indicates a scroll position of the submenu that corresponds to the battery notification. An informational wireless network notification may include a submenu value for the network submenu and a scroll position that corresponds to wireless networks. Thus, computing device 122 is configured to receive a user input after the settings panel is displayed and display a submenu associated with the operating state and in response to the second user input.

The computing device 122 may store the position for the submenu. When the user subsequently accesses the device settings menu 141, the most previous position is displayed. For example, if a notification 133 indicates low battery, the user scrolls down the notification 133 to reveal the device settings menu 141 and the expanded notification 145 illustrating batter information, and the user later accesses the device settings menu 141, the expanded notification will remain scrolled to the positon of the battery.

The notifications may be prioritized according to severity levels. The alert level may be prioritized over the advisory level and the informational level. The advisory level may be prioritized over the informational level. Within each level, sub-levels may also be prioritized. For example, user request messages may be prioritized over system messages and push messages.

The primary operating state may relate to a critical function of the computing device 122. The primary operating state may be a storage capacity state of the computing device 122 or a battery life of the computing device 122. The secondary operating state may relate to a wireless network, an operating system update, a mobile application update, a location status, or other features.

The device settings menu 141 may include components for network settings, accessory settings, device settings, cloud settings, capture settings, audio settings, location settings, and battery settings. The network settings may include no alert notifications or advisory notifications. The network settings may include informational notifications for searching for a network, connecting to the network, airplane mode status, signal strength status, and network type.

The accessories settings may include no alert notifications or advisory notifications. The accessories settings may include informational notifications for connecting to universal serial bus (USB) device, connecting to a Bluetooth device, connecting to an external sensor, or connecting to an external accessory. Example accessories include dials, lens, and zooms. Example external sensors may include GPS, IMU, Lidar, or other sensors.

The device settings may include alert notifications for storage full or reboot requirements. A reboot may be requirement because of an operating system update. The device settings may include advisory notifications when an update is available or when storage is running low (but not yet in a critical condition). The device settings may include informational notifications when an update is installing or diagnostics are being sent to an external device (e.g., server 125).

The cloud settings may include no alert notifications. The cloud settings may include an advisory notification to indicate that cloud syncing is unavailable or has been stopped. The cloud settings may include an informational notification when syncing is in process as normally scheduled.

The audio settings may include no alert notifications or advisory notifications. The audio settings may include informational notifications for displaying volume settings or mute status. The location settings may include no alert notifications or advisory notifications. The location settings may include informational notifications for map updates.

The battery settings may include alert notifications, advisory notifications, and informational notifications as a function. The computing device 122 may compare a current battery to one or more thresholds. When the battery level is above a first threshold no notification is generated. When the battery level falls below the first threshold, an informational notification is generated to indicate the battery level. Examples for the first threshold are 40% and 60%. Alternatively, the informational notice may be generated at any battery level, even above the first threshold. Below the first threshold and above a second threshold, the computing device 122 may generate an advisory notification. The advisory notification may indicate that the battery level is low but not yet critical. Examples for the second threshold may be 10% or 20%. Below the second threshold, the computing device 122 may generate an alert notification that indicates battery is critically low.

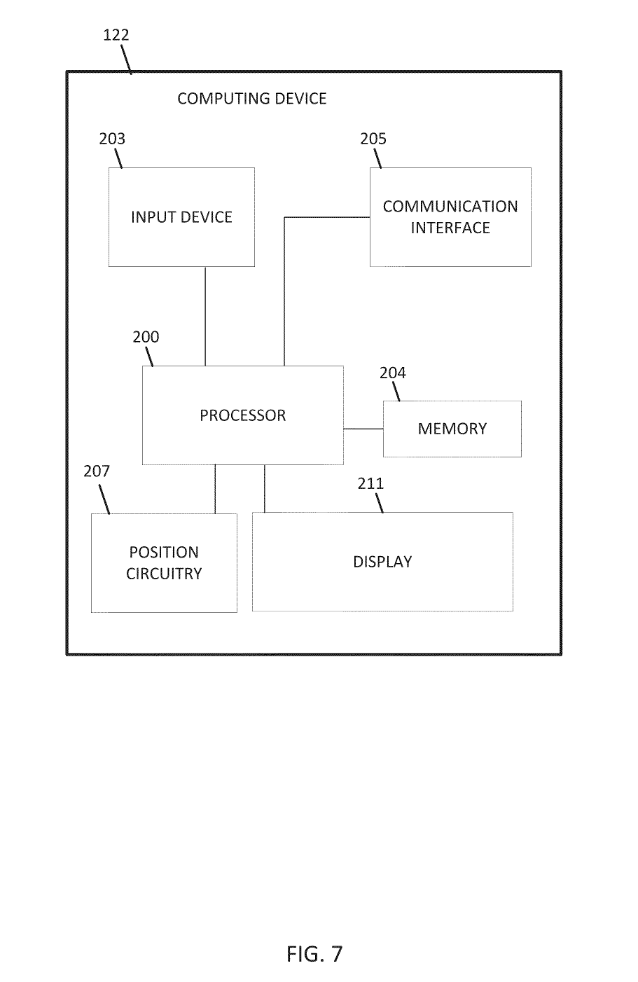

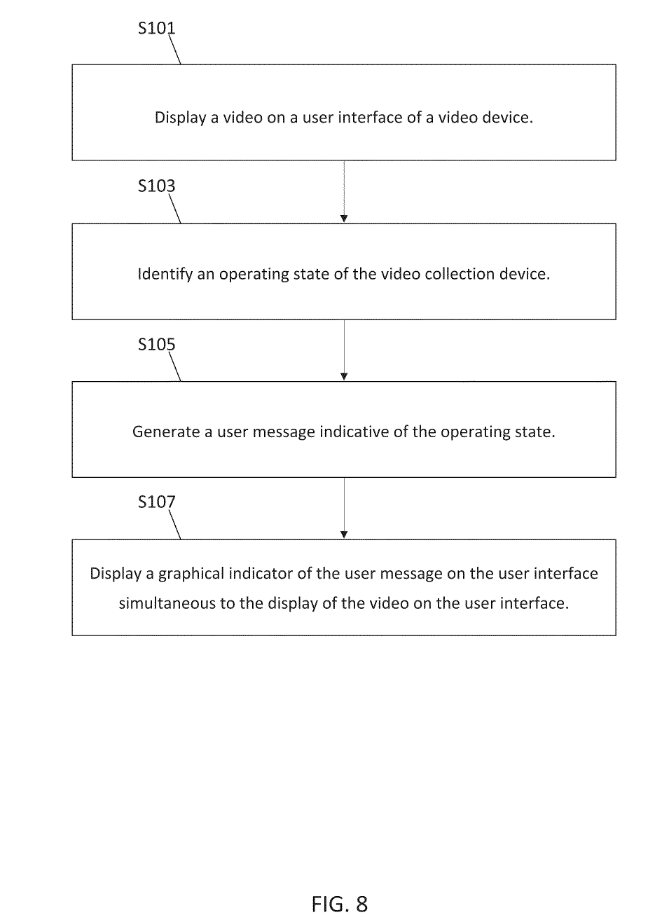

FIG. 7 illustrates an exemplary mobile device 122 of the system of FIG. 1. The mobile device 122 includes a processor 200, a memory 204, an input device 203, a communication interface 205, position circuitry 207, and a display 211. Additional, different, or fewer components are possible for the mobile device/personal computer 122. The functions described above may be generally performed by processor 200, and instructions for the processor 200 may be stored in memory 204. The notifications may be stored in memory 204.

At act S101, the processor 200 may cause the display 211 to display a video on a user interface of a video device (e.g., mobile device 122). The video device may be a camera that collects video images or a terminal that displays video images (or both). The processor 200 may overlay position data or motion data on the images that are collected or displayed. The processor 200 may store position data or motion as metadata with the images that are collected. The position circuitry 207 may generate the position data based on the geographic position of the video device and the motion data based on movement of the video device.

The memory 204 may store a plurality of operating states of the video device. The operating states may be classified (e.g., critical and non-critical) according to severity. For example, critical operating states may occur when a battery level falls below a predetermined level (e.g., 10%) or when storage level of the memory 204 reaches a predetermined level (e.g., 95%). A critical operating state may cause the mobile device to stop displaying the video after a time period. For example, when the battery is at the predetermined level, the video device only has enough power to run for some time period. When the storage level is at the predetermined level, and the video device is recording video, the video device only has enough storage space to continue for some time period. Non-critical operating states may include network status, personal messaging or any of the other operating states discussed above.

The memory 204 may store a lookup table that associates an alphanumeric code (e.g., A123) with the menu associated with the settings for the operating state. The lookup table may include a menu identifier and a scroll position for each of the operating states.

At act S103, the processor 200 is configured to identify an operating state of the video collection device. At act S105, the processor 200 is configured to generate a user message indicative of the operating state. The user message is not immediately displayed on the display 211. Instead, the processor 200 generates a graphical indicator that can be discreetly or unobtrusively display along with the video on the display 211 to inform the user that a user message is waiting for him but not disrupt the playing or recording video. The graphical indicator may be a single row of pixels having a predetermined with (e.g., 1-100 pixels), that is presented near one of the edges of the video.

The graphical indicator may be encoded according to the severity of the user message. For example, different severity levels are displayed with different colors, different lengths, or different widths. The term length may correspond to a direction parallel to the longitudinal axis of the display 211 (and on the surface of the display 211). The term width may correspond to a direction perpendicular to the longitudinal axis of the display 211. (and on the surface of the display 211).

At act S107, the processor 200 is configured to cause the display 211 to display the graphical indicator of the user message on the user interface simultaneous to the display of the video on the user interface such that the graphical indicator does not interrupt the video.

The processor 200 is configured to receive a continuous user input through the graphical indicator. At a first point in the continuous user input, the processor 200 causes a settings panel to be overlaid on the video on the user interface. At a second point in the continuous user input, the processor 200 causes display a sub-menu associated with the operating state and in response to the second user input.

The processor may identify the sub-menu based on the menu identifier and scroll position associated with the user message in the lookup table of memory 204. The menu identifier may determine with of the sub-menus are associated with the operating state, and the scroll position may determine a position for the sub-menu prior to display of the sub-menu being shown on the user interface.

The position circuitry 207 generates data indicative of the location of the mobile device 122. In addition or in the alternative to GPS, the position circuitry may include a dead reckoning-type system, cellular location, or combinations of these or other systems. The positioning circuitry may include suitable sensing devices that measure the traveling distance, speed, direction, and so on, of the mobile device 122. The positioning system may also include a receiver and correlation chip to obtain a GPS signal.

The computing device processor 200 may include a general processor, digital signal processor, an application specific integrated circuit (ASIC), field programmable gate array (FPGA), analog circuit, digital circuit, combinations thereof, or other now known or later developed processor. The mobile device processor 200 may be a single device or combinations of devices, such as associated with a network, distributed processing, or cloud computing. The computing device processor 200 may also be configured to cause an apparatus to at least perform at least one of methods described above.

The memory 204 may be a volatile memory or a non-volatile memory. The memory 204 may include one or more of a read only memory (ROM), random access memory (RAM), a flash memory, an electronic erasable program read only memory (EEPROM), or other type of memory. The memory 204 may be removable from the mobile device 122, such as a secure digital (SD) memory card.

The communication interface 205 may include any operable connection. An operable connection may be one in which signals, physical communications, and/or logical communications may be sent and/or received. An operable connection may include a physical interface, an electrical interface, and/or a data interface. The communication interface 205 provides for wireless and/or wired communications in any now known or later developed format.

In the above described embodiments, the network 127 may include wired networks, wireless networks, or combinations thereof. The wireless network may be a cellular telephone network, an 802.11, 802.16, 802.20, or WiMax network. Further, the network 127 may be a public network, such as the Internet, a private network, such as an intranet, or combinations thereof, and may utilize a variety of networking protocols now available or later developed including, but not limited to TCP/IP based networking protocols.

While the non-transitory computer-readable medium is described to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term “circuitry” or “circuit” refers to all of the following: (a)hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., E PROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C. F. R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

We claim:

1. A method comprising:
collecting video through a camera of a video collection device;
displaying the video on a user interface of the video collection device;
identifying, at a processor, an operating state of the video collection device;
generating, by the processor, a user message indicative of the operating state; and
displaying a graphical indicium of the user message on the user interface simultaneous to the display of the video on the user interface.

2. The method of claim 1, further comprising:
generating position data or motion data for the video collection device; and
storing the position data or the motion data with the video.

3. The method of claim 1, wherein the graphical indicium is a single row of pixels or less than 1% of a dimension of the user interface.

4. The method of claim 1, further comprising:
receiving a user input on the graphical indicium; and
displaying a settings panel in response to the user input.

5. The method of claim 4, wherein the settings panel is overlaid on the video on the user interface.

6. The method of claim 4, wherein the user input is a first user input, the method further comprising:
receiving a second user input after the settings panel is displayed; and
displaying a sub-menu associated with the operating state and in response to the second user input.

7. The method of claim 6, wherein the first user input and the second user input are a continuous swipe on the user interface.

8. The method of claim 3, wherein the operating state is an alert related to a critical component of the video collection device.

9. The method of claim 3, wherein the graphical indicium is a critical graphical indicium, the method further comprising:
identifying a non-critical operating state of the video collection device;
generating a non-critical user message indicative of the operating state; and
displaying a non-critical graphical indicium of the user message on the user interface simultaneous to the display of the video on the user interface.

10. The method of claim 1, further comprising:
identifying a sub-menu associated with the operating state; and
determining a position for the sub-menu prior to display of the sub-menu being shown on the user interface; and
displaying the sub-menu associated with the operating state.

11. An apparatus comprising:
at least one processor; and
at least one memory including computer program code for one or more programs; the at least one memory and the computer program code configured to, with the at least one processor, cause the apparatus to at least:
display a video on a user interface of a video device;
identify an operating state of the video device;
generate a user message indicative of the operating state; and
display a graphical indicium of the user message on the user interface simultaneous to the display of the video on the user interface, wherein the graphical indicium is coded based on the severity of the user message.

12. The apparatus of claim 11, wherein the graphical indicium is a row of pixels or less than 1% of a dimension of the user interface.

13. The apparatus of claim 11, the at least one memory and the computer program code configured to, with the at least one processor, cause the apparatus to at least:
receive a user input on the graphical indicium; and
display a settings panel in response to the user input.

14. The apparatus of claim 13, wherein the graphical indicium is on an edge of the video and the settings panel is overlaid on the video on the user interface.

15. The apparatus of claim 13, the at least one memory and the computer program code configured to, with the at least one processor, cause the apparatus to at least:
receive a second user input after the settings panel is displayed; and
display a sub-menu associated with the operating state and in response to the second user input.

16. The apparatus of claim 15, wherein the first user input and the second user input are a continuous swipe on the user interface.

17. The apparatus of claim 11, the at least one memory and the computer program code configured to, with the at least one processor, cause the apparatus to at least:
identify a non-critical operating state of the video device;
generate a non-critical user message indicative of the operating state; and
display a non-critical graphical indicium of the user message on the user interface simultaneous to the display of the video on the user interface.

18. The apparatus of claim 11, the at least one memory and the computer program code configured to, with the at least one processor, cause the apparatus to at least:
identify a sub-menu associated with the operating state; and
determine a position for the sub-menu prior to display of the sub-menu being shown on the user interface; and
display the sub-menu associated with the operating state.

19. A non-transitory computer readable medium including instructions that when executed cause a processor to:
display a video on a user interface of a mobile device;
identify a critical operating state of the mobile device, wherein the critical operating state may cause the mobile device to stop displaying the video after a time period;
generate a user message indicative of the critical operating state; and
display a graphical indicator of the user message on the user interface simultaneous to the display of the video on the user interface, wherein the graphical indicator does not interrupt the video and is non-textual.

20. The non-transitory computer readable medium of claim 19, wherein the graphical indicator is coded as a function of the severity of the critical operating state.
